(19) United States
(12) Patent Application Publication
(10) Pub. No.: US 2022/0120098 A1
(43) Pub. Date: Apr. 21, 2022

(54) TILE ADHESIVE SPREADER SYSTEM

(71) Applicant: Eliyahu Meir TURGEMAN, Netivot (IL)

(72) Inventor: Eliyahu Meir TURGEMAN, Netivot (IL)

(21) Appl. No.: 17/428,297

(22) PCT Filed: Jan. 30, 2020
(86) PCT No.: PCT/IL2020/050114

§ 371 Date: Aug. 4, 2021

(30) Foreign Application Priority Data
Feb. 11, 2019 (IL) 264779

(51) Int. Cl. E04F 21/12; B05C 17/00; B05B 1/20; B05B 9/04

(52) U.S. Cl. CPC E04F 21/12; B05B 9/0403; B05B 1/20; B05C 17/002

(57) ABSTRACT

The present invention, in some embodiments thereof, relates to a spreader for spreading paste (for example a tile adhesive) over a surface and more particularly, but not exclusively, to a system for pumping and uneven spreading of adhesive along a surface of a building. For example, the system may include a source of the paste optionally including a mixer, driver and/or conveyer. The paste may be driven to a spreader. For example, the spreader may deposit the paste unevenly over a surface. For example, the spreader may include multiple outlets and/or an uneven spreading blade (for example in the form of a comb). For example, the paste may be spread as lines across the surface.

### RELATED APPLICATION/S

This application claims the benefit of priority of Israeli Patent Application No. 264779 filed 11 Feb. 2019. the contents of which are incorporated herein by reference in their entirety.

### FIELD AND BACKGROUND OF THE INVENTION

The present invention, in some embodiments thereof, relates to a spreader for spreading paste over u surface and, more particularly, but not exclusively, to a system for to automate part of the process of tiling a floor.

Tiles, including floor tiles, are usually adhered to a surface by means of a tile adhesive. During installation, a tile installer may keep the adhesive inside a bucket and may use a hand tile spreader to spread the adhesive to a required thickness over the whole surface onto which the tile is to be adhered. Generally, when applying the adhesive, some of the adhesive drops onto the floor from the spreader requiring later cleaning of the floor to remove the adhesive. Additionally, use of the hand spreader generally results in some of the adhesive sticking to the installer's hands.

Occasionally, spreading the adhesive over the whole surface to be tiled is not necessary and it is sufficient to spread the adhesive with the hand spreader in row segments which are distanced one from the other. The adhesive then spreads to cover the whole under surface of the tile when the tile is pressed onto the surface to be tiled. Generally, this technique requires a certain degree of expertise as the amount of adhesive applied may be insufficient or may be too great, which may require that the tile be removed after placement to correct the deficiency.

### SUMMARY OF THE INVENTION

According to an aspect of some embodiments of the invention, there is provided a system for spreading compound onto a surface including: a mixing tank configured for storing and mixing the compound; an applicator configured for spreading the compound onto the surface according to a predefined pattern; a conveyer connecting providing a transport path for the compound from the mixing tank to the applicator; a driver for driving the compound from the tank along the conveyer to the applicator; the applicator including an egress configured to release the compound in a predetermined uneven pattern.

According to some embodiments of the invention, the applicator further includes: an uneven blade attached to the egress with protrusions synchronized to the egress.

According to some embodiments of the invention, the blade has the form a comb.

According to some embodiments of the invention, each tooth of the comb is associated with a point of increased rate release of the compound of the egress.

According to some embodiments of the invention, each tooth of the comb is associated with a point of decreased rate release of the compound of the egress.

According to some embodiments of the invention, the applicator includes trigger having a connector configured for reversible connection to the egress.

According to some embodiments of the invention, the egress includes multiple openings for release of the compound.

According to some embodiments of the invention, the multiple openings are evenly spaced along a line.

According to some embodiments of the invention, the conveyer is flexible.

According to an aspect of some embodiments of the invention, there is provided a system for spreading compound onto a surface including; a mixing lank configured for storing and mixing the compound; an applicator configured for spreading the compound onto the surface according to a predefined pattern; a conveyer connecting providing a transport path for the compound from the mixing tank to the applicator; a pump for driving the compound from the tank along the conveyer to the applicator; the applicator including an egress configured to release the compound a blade with an uneven spreading edge fixed to the egress.

According to some embodiments of the invention, the egress is configured to deposit the compound unevenly over a surface.

According to some embodiments of the invention, the egress includes multiple outlets.

According to some embodiments of the invention, the egress is configured to deposit the compound in multiple lines along the surface.

According to some embodiments of the invention, the applicator includes a regulator for controlling a rate of the release of the compound.

According to some embodiments of the invention, the applicator includes a meter for indicating a rate of the release of the compound.

According to an aspect of sonic embodiments of the invention, there is provided a method for depositing an adhesive onto a surface including: providing an adhesive spreading device include a mixer a conveyer and an applicator; mixing the adhesive in the mixer; driving the adhesive along the conveyer to the applicator and passing the applicator over the surface thereby depositing the adhesive unevenly across the surface.

According to some embodiments of the invention, the method further includes: measuring an actual deposition rate; comparing the actual deposition rate to a desired deposition rate; adjusting a regulator lo bring the actual rate closer to the desired rate.

According lo some embodiments of the invention, the applicator includes an uneven blade and wherein the passing the applicator includes shaping the deposited adhesive unevenly with the uneven blade.

According to some embodiments of the invention, the applicator includes an uneven egress and wherein the passing the applicator includes depositing the adhesive unevenly with the uneven egress.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OP THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 schematically illustrates an exemplary tile adhesive spreader system, according to an embodiment of the present invention;

FIG. 2 schematically illustrates the tile adhesive spreader system, according to an embodiment of the present invention;

FIG. 3 is a block diagram illustration of an adhesive spreader system in accordance with an embodiment of the current invention;

FIG. 4 is a block diagram illustration of an adhesive spreader system in accordance with an embodiment of the current invention;

FIG. 5A is a block diagram illustration of an adhesive spreader system handle in accordance with an embodiment of the current invention;

FIG. 5B is a block diagram illustration of an adhesive spreader system applicator in accordance with an embodiment of the current invention;

FIG. 6 is a block diagram illustration of an adhesive spreader system handle in accordance with an embodiment of the current invention;

FIG. 7 is a schematic illustration of an adhesive spreader system in accordance with an embodiment of the current invention;

FIG. 8 is a schematic illustration of an adhesive spreader system applicator in accordance with an embodiment of the current invention;

FIG. 9 is a schematic illustration of an adhesive spreader system applicator in accordance with an embodiment of the current invention;

FIG. 10 is a schematic illustration of an adhesive spreader system applicator in accordance with an embodiment of the current invention;

FIG. 11 is a schematic illustration of an adhesive spreader system applicator in accordance with an embodiment of the current invention;

FIG. 12 is a flow chart illustration of a method of spreading adhesive in accordance with an embodiment of the current invention;

FIG. 13 is a flow chart illustration of a method of spreading adhesive in accordance with an embodiment of the current invention;

FIG. 14 is a schematic illustration of an adhesive applicator with multiple outlets and a pattern of adhesive deposited in accordance with an embodiment of the current invention;

FIG. 15 is a schematic illustration of an adhesive applicator with a single small outlet and a pattern of adhesive deposited in accordance with an embodiment of the current invention; and

FIG. 16 is a schematic illustration of an adhesive applicator with a single large outlet and a pattern of adhesive deposited in accordance with an embodiment of the current invention.

### DESCRIPTION OF SPECIFIC EMBODIMENTS OF THE INVENTION

The present invention, in some embodiments thereof, relates to a spreader for spreading paste over a surface and, more particularly, but not exclusively, to a system for pumping and uneven spreading of adhesive along a surface of a building.

### Overview

An aspect of the present invention relates to a tile adhesive spreader system which is pressure based to allow smooth flow of the tile adhesive from a storage container to a comb-shaped spreader unit having multiple outlets for applying the adhesive. The storage container, when closed, is configured to allow an applied pressure to build up in an interior volume space above the adhesive to force adhesive flow out an attached conduit to the spreader. Optionally, liquid-based materials other titan adhesives may be used, not necessarily limited to tile adhesive spreading applications (e.g. plaster, glues, grouts, paints, etc.).

In some embodiments, the applied pressure may be based on the type of adhesive to be applied and may be regulated to control a flow amount and/or a flow speed. The spreader outlets may be replaceable and may be of different sizes depending on tire type of adhesive to be applied, or on the flow amount and/or flow speed.

In some embodiments, the device includes a compressor which may pump a gas under pressure into the closed container. The gas may include, but not be limited to air. A conduit conducts the pressured gas from the compressor into the container. The compressor may include a pressure gauge which may be used to calibrate the applied pressure. Additionally or alternatively, a pressure gauge on the spreader may allow calibrating the applied pressure. An adjustable valve on the spreader may serve to regulate the flow amount and/or flow speed.

In some embodiments, the device may include a mixing unit which may serve to mix the tile adhesive to prevent it iron changing viscosity. The mixing unit may include one or more mixing blades inside the container which may be driven by an external electric motor.

In some embodiments, the device may be manually transported (pulled/pushed), or may be mechanically transported using a vehicle. The storage container may include different sizes, all of which may have suitably sized covers and which make the container substantially hermetic when closed. The conduits may be removable for cleaning and for replacement and may include different lengths.

### Detailed Embodiments

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

### Description of Exemplary Embodiments

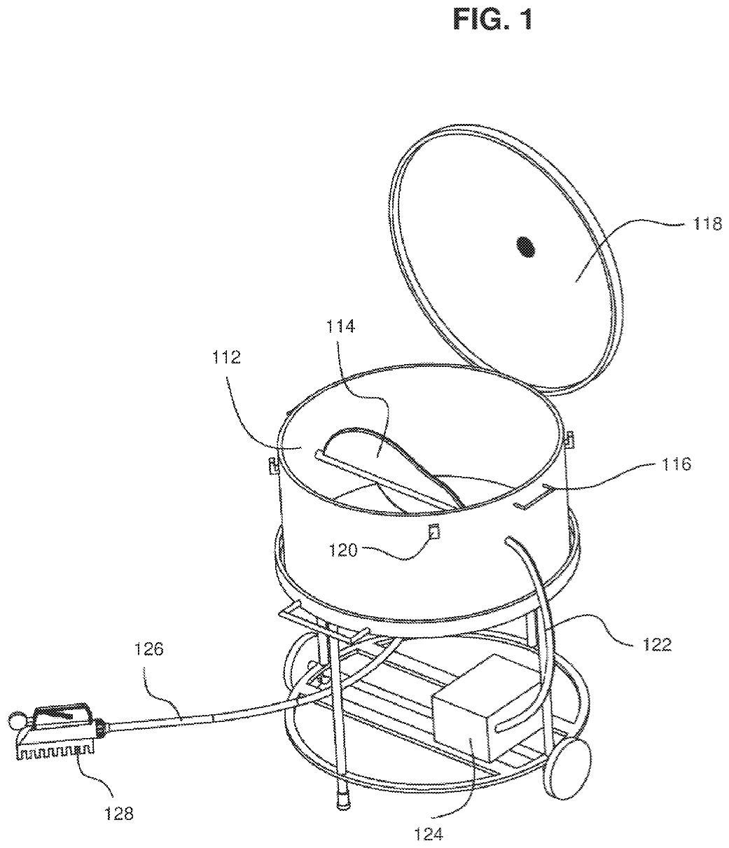

of the Present Invention Figure 1 schematically illustrates an exemplary tile adhesive spreader system, according to in embodiment of the present invention. Shown in the Figure is a tile adhesive container 112 including a mixer 114. Also shown are handles 116 for manually pulling the device, a cover 118 for the container 112, and fasteners 120 to secure the cover to the container when closed.

Optionally the spreader drives the paste using air pressure. For example, a driver may include A first hose 122 conducts air from a compressor 124 into die container and forces the tile adhesive out a conveyer, e.g. a second hose 126. At a distal end of hose 126 is a spreader 128 through which the tile adhesive may exit the hose for spreading. Optionally, hose 122 and/or compressor may be configured for working pressures of between 6 to 10 Bar and/or between 10 to 20 bar and/or between 20 to 50 bar. Alternatively or additionally, an adhesive spreader may use a worm drive and/or other driver. A spreader 128 is optionally, decidesth

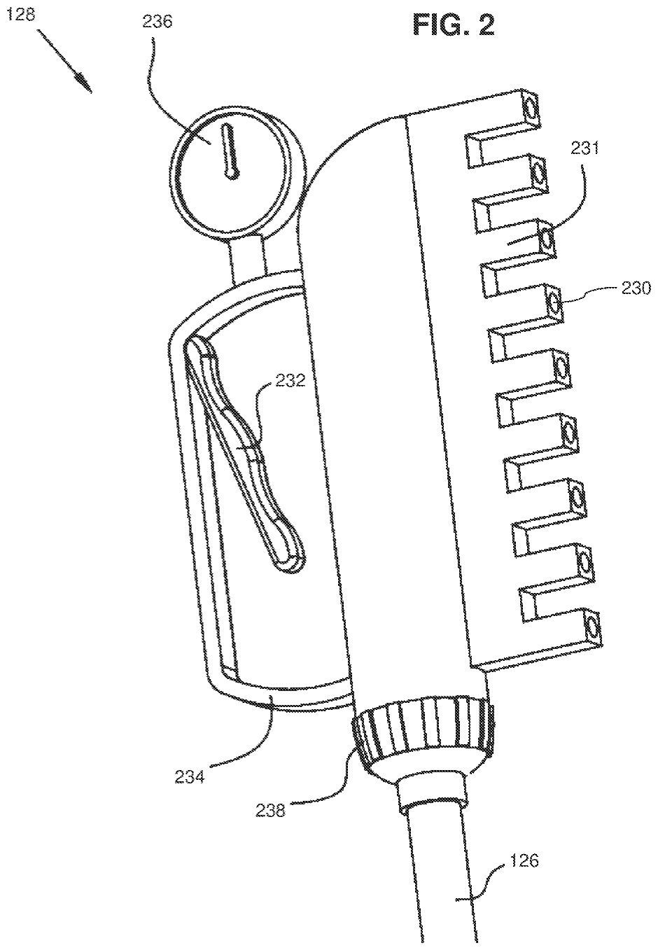

FIG. 2 schematically illustrates a spreader 128 of a tile adhesive spreader system, according to an embodiment of tic present invention. Shown in the figure is an enlarged view of the spreader 128 into which the adhesive flows from hose 126. The adhesive flowing into the spreader 128 is directed through a handle to a replaceable applicator 231. Optionally, the spreader 128 is responsive to pressing of a trigger 232 on a handle 234 of the device. The spreader 128 additionally includes a pressure gauge 236 and an adjustable valve 238 to regulate the amount of adhesive flowing out of the applicator 231.

In some embodiments, the applicator 231 has the form of a comb having a plurality of outlets 230. For example, the comb may be detachable connected and/or in fluid communication with conveyer 126 via a handle. Optionally, adhesive is pumped from conveyer 126 through the handle to applicator 231. For example, applicator 231 may have the form of a comb may include multiple teeth, each tooth having an outlet 230 for releasing adhesive. Optionally, the adhesive will be released onto a surface in a plurality of lines, one line associated with each outlet 230. For example, the adhesive is expelled through each of a line of outlets 230 in response to pressing a trigger 232.

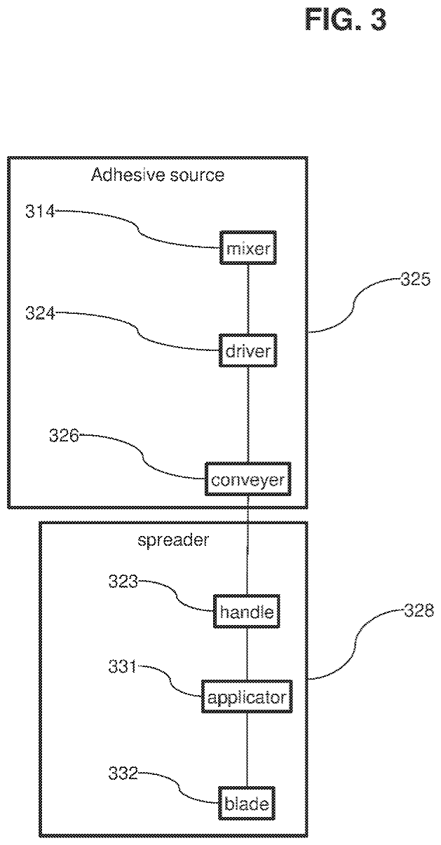

FIG. 3 is a block diagram illustration of an adhesive spreader system in accordance with an embodiment of the current invention. Optionally the device includes an adhesive source 325 and a spreader 328.

In some embodiments, the adhesive source 325 may include a mixer. Optionally, the mixer is configured to store and/or agitate a paste such as cement and/or mortar and/or putty. For example, agitation may be strong enough to prevent the paste from drying and/or homogenize the paste. Optionally the paste may have a density ranging between 1000 to 12000 kg/m3 anti/or between 1200 to 1600 and/or between 1600 to 2000 kg/m3 and/or between 2000 to 2600 kg/m3. The compression strength of Lite paste may range between 15 to 30 N/mm² and/or between 30 to 45 N/mm² and/or between 5 to 15 N/mm².

In some embodiments, the adhesive source 325 may include a driver 324 that drives the adhesive to the spreader 328. For example, the drive may include a piston pump and/or a worm drive and/or a continuous mixing pump and/or an air pressure pump. Optionally, the hose may he made to withstand pressures up to 10 bar and/or up to 30 bar and/or up to 70 bar and/or up to 120 bar.

In some embodiments, an adhesive source may include a conveyer 326. For example, the conveyer 326 may include a flexible hose. Optionally, the diameter of a hose may range between 5 to 10 mm and/or between 10 to 30 mm and/or between 30 to 90 mm.

Optionally the conveyer connects an adhesive tank and/or adhesive mixer 314 and/or the adhesive driver 324 to a spreader 328.

In some embodiments, the spreader may include a handle 323 connected to conveyer 326 and/or an applicator 331 reversibly connected to the handle 323. For example, the applicator 331 and/or a spreading blade 332 may be switchable. For example, exchangeable applicators 331 may include a single outlet and/or multiple outlets. For example, the applicator 331 and/or blade 332 may snap to the handle 323 (e.g. with an interference element) and/or slide onto the handle 323 (e.g. along a track and/or with a tongue and groove structure) and/or be connected using a connector (e.g. a bolt) and/or screwed to the handle 323. Optionally the blade 332 and the applicator (e.g. an egress thereof) are integral to a single piece and/or permanently connected and/or synchronized. Alternatively or additionally, the blade 332 and the applicator may be separable and/or independent.

For example, an applicator may have multiple outlets distanced between 3 to 10 mm apart and/or between 10 to 30 mm apart and/or between 30 to 50 mm apart and/or between 50 to 100 mm apart. Outlets may be positioned on the teeth of a comb and/or between the teeth. Optionally each outlet has a width of between 1 to 3 mm and/or between 3 to 10 mm and/or between 10 to 20 mm. Optionally, the outlets may be circular and/or square and/or oval and/or rectangular and/or another shape. For example, the ratio of the length to width of an outlet may range between 1 to 1.5 and/or between 1.5 to 3 and/or between 3 to 9 and/or between 9 to 100.

Optionally an applicator 331 and/or a spreading blade 332 may have a comb shape and/or a flat shape and/or a serpentine shape. For example, teeth of a comb may-be spaced between 1 to 3 mm apart and/or between 3 to 10 mm apart anti/or between 10 to 20 mm apart. For example, teeth of a comb may be between 1 to 3 mm wide and/or between 3 to 10 mm wide and/or between 10 to 20 mm wide.

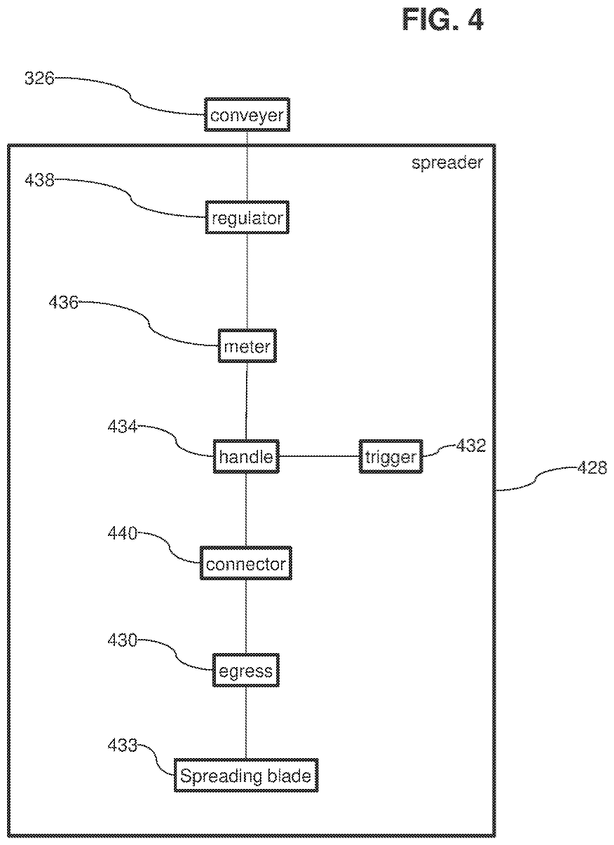

FIG. 4 is a block diagram illustration of an adhesive spreader 428 in accordance with an embodiment of the current invention. In some embodiments a spreader may include a regulator 438. For example, a regulator 438 may include an adjustable valve and/or opening that can be adjusted. Optionally the regulator 438 may be adjusted to set a deposition rate of the adhesive. In some embodiments, the rate of deposition may a trigger may be also be controlled by a trigger 432. For example, the trigger may be connected to a variable resistance valve and/or a rate of deposition may increase as the trigger is pulled further. For example, the regulator 438 may control the maximum rate of deposition when the trigger 432 is fully pulled (activated). Optionally, the spreader 428 and/or a cement source may include a meter 436 that measures a rate of deposition of the adhesive. Alternatively or additionally, there may be cumulative deposition indicator. The trigger 432, regulator 438 and/or trigger 432 are optionally connected to a handle 434 that is configured for being held by a worker who to spread adhesive on a surface (e.g. a wall and/or a floor). Optionally the handle 434 also includes a connector 440 for reversibly connecting the handle to a spreading blade 433 and/or an adhesive egress 430 (e.g. and supplying a flow path for providing paste through the handle 434 to the egress 430). For example, various different egress 430 geometries and/or spreading blades 431 may be connected to the handle 434 for example to spread different types of paste and/or to spread paste with different depositional patterns. For example, an egress may include a large number of outlets for depositing multiple strips of adhesive and/or a single opening. Optionally each opening may be circular and/or symmetric and/or equilateral and/or elongated and/or square and/or rectangular and/or oval. Alternatively or additionally, an egress 430 and/or spreading blade 433 may permanently fixed to the handle 434. Optionally, the geometry of the blade 433 and/or egress 430 may be adjustable (for example, an egress may have multiple outlets some or all of which may be blocked for example to change the deposition geometry). Alternatively or additionally, the deposition geometry may be fixed.

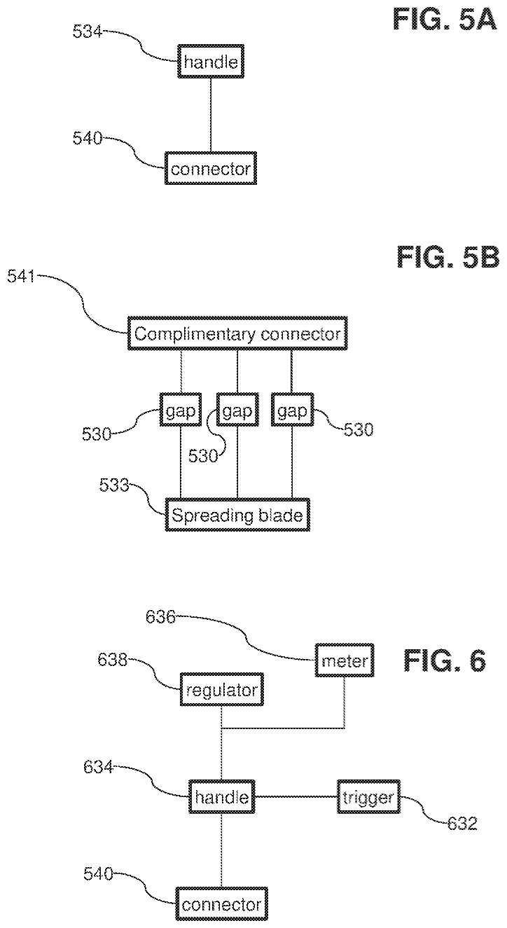

FIG. 5A is a block diagram illustration of an adhesive spreader system and FIG. 5B is a block diagram illustration of an adhesive spreader system applicator in accordance with an embodiment of the current invention. Optionally, a handle 534 maybe include a connector 540 configured to reversibly attach to complimentary connector 541 of an applicator. Optionally, the applicator includes an egress including one or more outlets (e.g. gaps 530). Attaching the applicator to the handle optionally supplies a fluid path for pumping paste (e.g. tiling adhesive) therethrough and/or depositing the paste onto a surface. Optionally the applicator includes a spreading blade 533 configured to spread and/or smooth and/or texture the deposited paste on a surface.

FIG. 6 is a block diagram illustration of an adhesive spreader system handle in accordance with an embodiment of the current invention. Different handles may attach to the same applicator. For example, a handle may include a connector 540 to connect to a variety of a applicators. For example, a handle may include accessories to facilitate control over a deposition rate (for example a regulator 638 and/or a flow meter 636). Alternatively or additionally, a handle 634 may have a geometry that facilitates deposition of various surfaces. For example, rigid tube may be supplied between the trigger 632 and the connector 540 (and/or the applicator) for example for spreading adhesive onto a floor while standing (e.g. similar in form to a vacuum cleaner handle). For example, an extending applicator may be supplied for depositing material onto a ceiling and/or a higher region of a wall. Alternatively or additionally, a short applicator handle 634 may be supplied for more easily accessed surfaces (e.g. lower portions of a wall etc.).

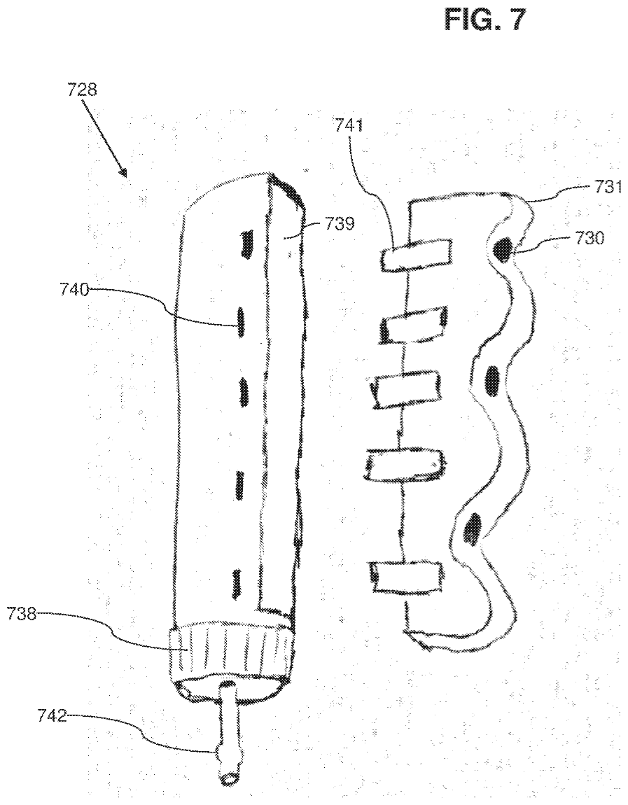

FIG. 7 is a schematic illustration of an adhesive spreader system in accordance with an embodiment of the current invention. Optionally, a spreader 728 may include a fluid path 739 and/or connectors 740 that connect to complimentary connector elements 741 on an applicator 731. Optionally, when the connectors 740 and matching connector elements 741 on the applicator. For example, when connectors 740 and complimentary connecting elements 741 are connected, fluid path 739 may be joined to one or more outlets 730 of the applicator 731. Optionally, an applicator 731 may include a serpentine surface. For example, the applicator 731 may be used to deposit adhesive with a wavy surface geometry. Optionally, outlets 730 may be positioned on troughs between protrusions on the serpentine surface of the application 731. Alternatively or additionally, outlets may be positioned on protrusions on the surface of the application. Optionally, a spreader 728 includes a connector 742 for connecting to a conveyer (e.g. a flexible lube bringing adhesive from an adhesive source). Optionally, a regulator 738 is supplied for example to facilitate controlling a flow rale.

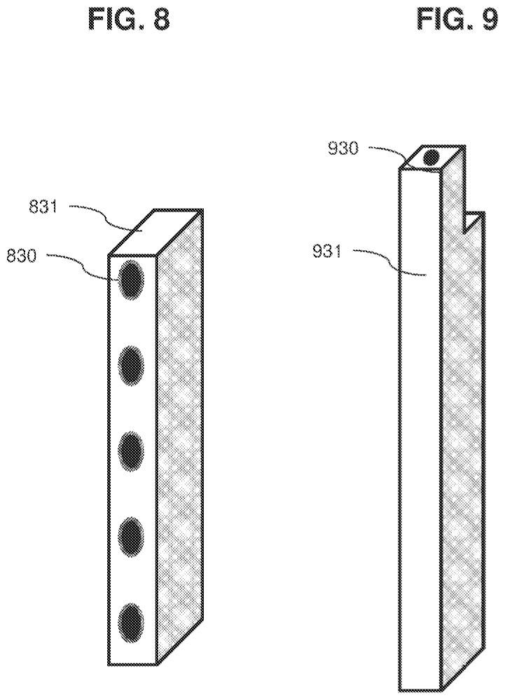

FIG. 8 is a schematic illustration of an adhesive spreader system applicator in accordance with an embodiment of the current invention. In some embodiments, an applicator 831 may include a plurality of outlets 830 arranged along a linear surface. Optionally the positions of the outlets 830 may be at fixed intervals (e.g. in order to deposit lines of tile adhesive to a flow at a set interval that facilitates sticking a tile to the floor). Alternatively or additionally, the positions of the outlets 830 may be adjustable (e.g. the outlets 830 may be positioned on sliding elements and/or may be individually closable for using a few outlets 830 far apart and/or a large number of outlets 830 at smaller spacing intervals). For example, multiple evenly spaced outlets 830 may be used to simultaneously deposit grout in spaces between a few rows of tiles. Optionally, a connector is supplied to allow swapping between applicators for different jobs.

FIG. 9 is a schematic illustration of an adhesive spreader system applicator in accordance with an embodiment of die current invention. In some embodiments, an applicator 931 may include an egress with a single outlet 930 arranged like a pistol. For example, the geometry of the exemplary applicator of FIG. 9 may be used to fill in grout between tiles and/or mortar between bricks. Optionally, a connector is supplied to allow swapping between applicators for different jobs.

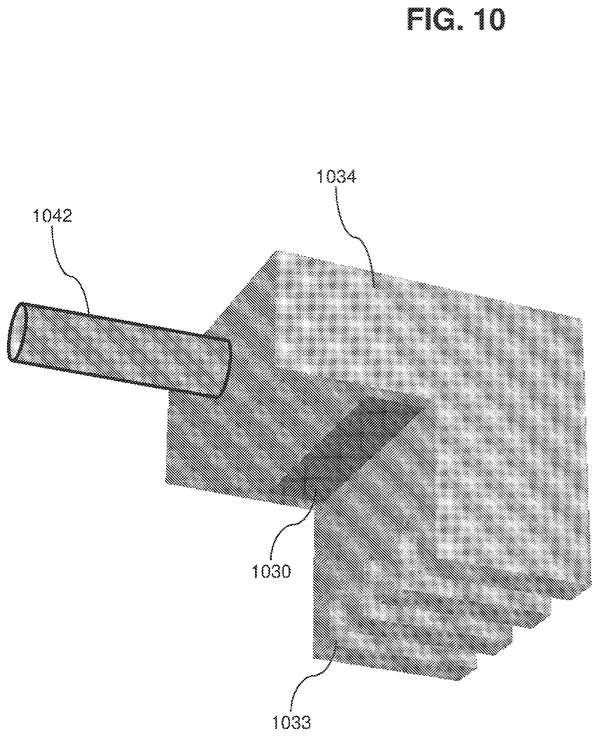

FIG. 10 is a schematic illustration of an adhesive spreader system applicator 1034 in accordance with an embodiment of the current invention. For example, an applicator 1034 may include a connector 1042 that supplies a fluid to path to a handle and/or an adhesive conveyer and/or an adhesive source. Optionally, the applicator 1034 channels the adhesive out an egress 1030. Optionally, the egress 1030 may be elongated. For example, the elongated egress 1030 may facilitate spreading adhesive evenly over a surface as the applicator is pulled along the surface. Optionally, a comb shaped spreading blade 1033 is supplied. For example, the blade 1033 may sculpt the surface of the adhesive to lines for example to enhance sticking of tiles to a surface.

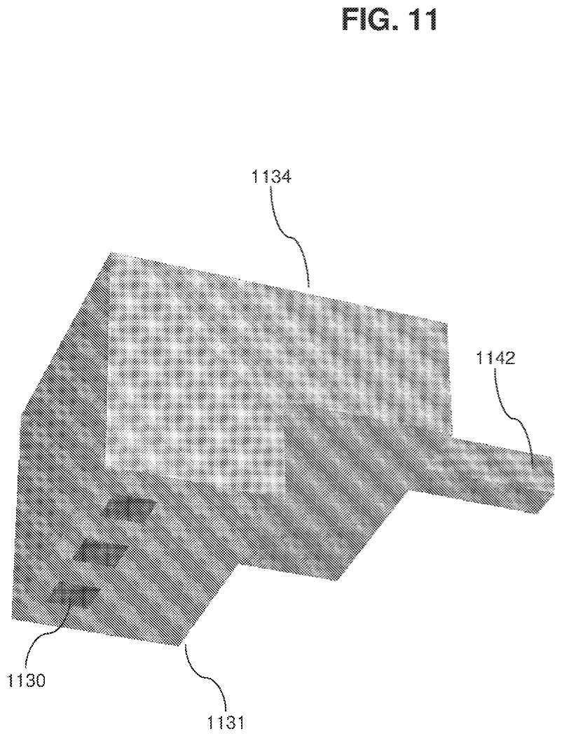

FIG. 11 is a schematic illustration of an adhesive spreader system applicator 1134 in accordance with an embodiment of the current invention. For example, an applicator 1134 may include a connector 1142 that supplies a fluid to path to a handle and/or an adhesive conveyer and/or an adhesive source. Optionally, the applicator 1134 channels the adhesive out an egress with multiple outlets 1130. Optionally, the egress 1030 may be elongated. For example, the elongated egress 1030 may facilitate spreading adhesive in lines over a surface as the applicator is pulled along the surface for example to enhance sticking of tiles to a surface.

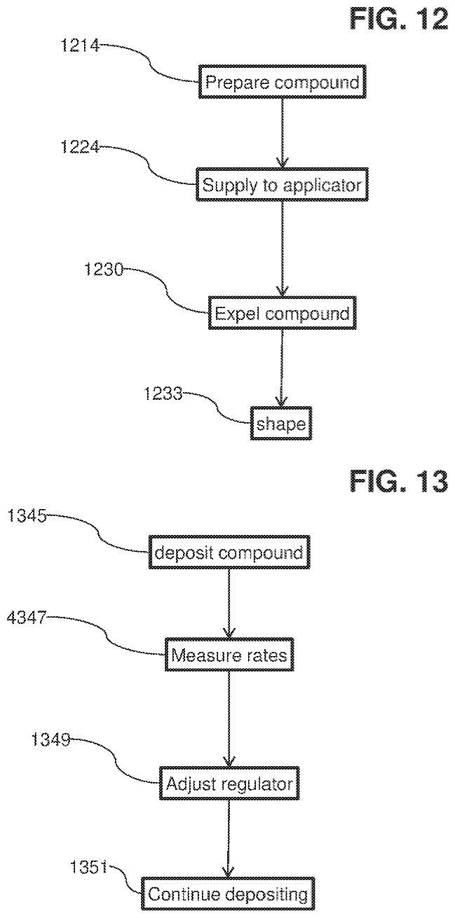

FIG. 12 is a flow chart illustration of a method of spreading adhesive in accordance with an embodiment of the current invention. In some embodiments, an adhesive spreader in accordance with an embodiment of the current invention will used to generate and/or deposit a compound (e.g. adhesive and/or mortar and/or grout and/or putty and/or plaster) onto a surface. For example, a mixer may be used to prepare 1214 the compound. Optionally, a driver (e.g. a pump) and/or is used to supply 1224 the compound to an applicator. The compound is optionally expelled 1230 from the applicator and/or deposited onto a surface. Optionally, the applicator is configured to deposit the compound in a preferred geometry (for example in lines and/or smoothly and/or into a crack). Optionally, the compound is then shaped 1233 over the surface. For example, there may be a surfacing blade attached to the applicator such that passing the applicator over the surface simultaneously deposits the compound and/or shapes the surface of the compound (e.g. spreading and/or forming into rows and furrows and/or another pattern.

FIG. 13 is a flow chart illustration of a method of spreading adhesive in accordance with an embodiment of the current invention. In some embodiments, a worker will start depositing 1345 a compound onto a surface. He may measure 4347 a rate of deposition and/or compare the rate of deposition to a desired rate of deposition. If the rate of deposition is different from the desired rale the worker may adjust 1349 a regulator. For example, if the original deposition rate was too high, the regulator may be used to adjust 1349 downward the deposition rate and/or if the original deposition rale was too low, the regulator may be used to adjust 1349 upward the deposition rate. Optionally, with the regulator properly adjusted, the worker will continue depositing 1351 the compound at a rate closer to the desired deposition rate. Optionally, the compound may be deposited evenly and/or unevenly across a surface.

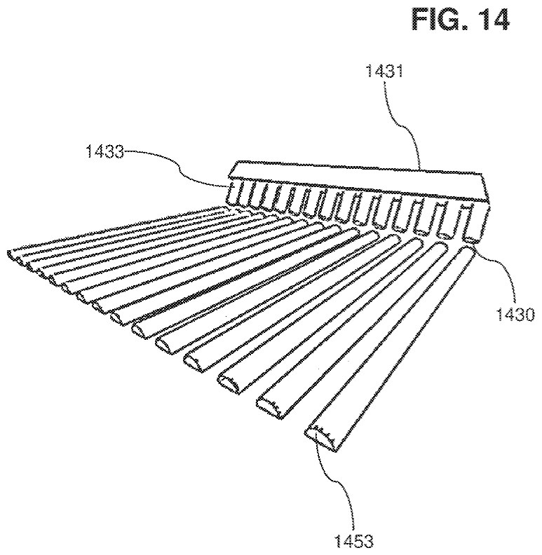

FIG. 14 is a schematic illustration of an adhesive applicator with multiple outlets and a pattern of adhesive deposited in accordance with an embodiment of the current invention. For example, the applicator 1431 as the form of a comb. Each tooth 1433 of the comb includes an outlet 1430. For example, applicator 1431 is attached to a handle through which adhesive is driven into the applicator 1431. Optionally, adhesive exits each of the outlets 1430. In some embodiments, the applicator 1431, the applicator 1431 is passed a surface (e.g. a floor) while the adhesive is driven out the applicator. As the applicator is passed along the surface, each outlet 1430 deposits a line 4153 of adhesive on the surface. Optionally, passing the applicator 1431 once along a surface deposits multiple lines 1453 of adhesive along the surface.

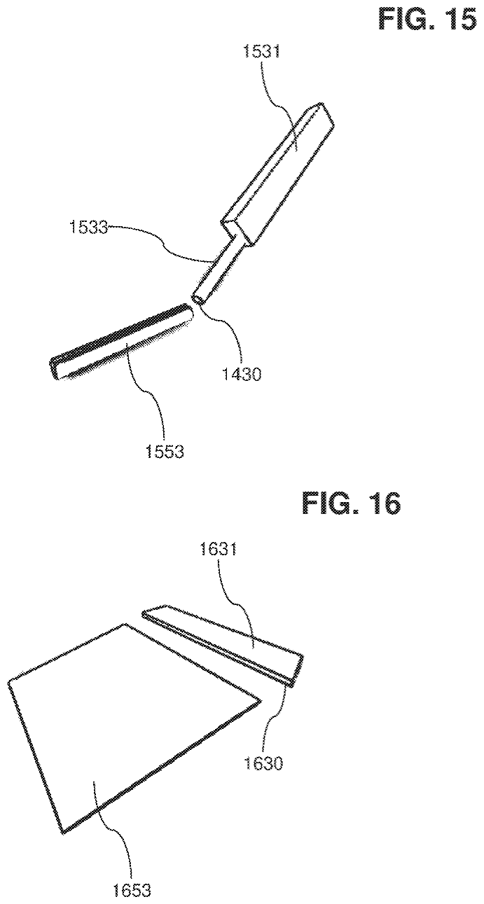

FIG. 15 is a schematic illustration of an adhesive applicator with u single small outlet and a pattern of adhesive deposited in accordance with an embodiment of the current invention. For example, an applicator 1531 may include a nozzle 1533 with a single outlet 1530. Optionally, driving adhesive (for example mortar and/or grout) out the outlet 1530 while moving the applicator along a surface produces a single line 1553 (a head) of adhesive on the surface. For example, this may be useful for applying grout between tiles and/or mortar between bricks.

FIG. 16 is a schematic illustration of an adhesive applicator with a single elongated outlet and a pattern of adhesive deposited in accordance with an embodiment of the current invention. For example, an applicator 1631 may include a single elongated outlet 1630. For example, the length of the outlet may range between 1 to 2 cm and/or between 2 to 5 cm and/or between 5 to 10 cm and/or between 10 to 50 cm. For example, the height of the outlet may range between 0.1 to 1 cm and/or between 1 to 2 cm and/or between 2 to 5 cm. Optionally, driving adhesive out the outlet 1630 while moving the applicator along a surface produces a coating 1653 (a thick layer) of adhesive on the surface. For example, the depth of the layer may range between 0.1 to 1 cm and/or between 1 to 2 cm and/or between 2 to 5 cm.

It is expected that during the life of a patent maturing from this application many relevant technologies will be developed and the scope of the terms are intended to include all such new technologies a priori.

As used herein the term “about” refers to ±10%

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, hut only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2to 4, from 2 to 6,from 3 to 6 etc., as well as individual numbers within that range, for example, 1,2, 3,4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween. When multiple ranges are listed for a single variable, a combination of the ranges is also included (for example the ranges from 1 to 2 and/or from 2 to 4 also includes the combined range from 1 to 4).

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has beer described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A system for spreading compound onto a surface comprising:
a mixing tank configured for storing and mixing the compound;
an applicator configured for spreading the compound onto the surface according to a predefined pattern;
a conveyer connecting providing a transport path for the compound from the mixing tank to the applicator;
a driver for driving the compound from the tank along the conveyer to the applicator,
said applicator including
an egress configured to release the compound in a predetermined uneven pattern.

2. The system of claim 1, wherein said applicator further includes:
an uneven blade attached to said egress with protrusions synchronized to said egress.

3. The system of claim 1, wherein said blade has the form a comb.

4. They system of claim 3, wherein each troth of said comb is associated with a point of increased rate release of said compound of said egress.

5. They system of claim 2, wherein each troth of said comb is associated with a point of decreased rate release of said compound of said egress.

6. The system of claim 1, wherein said applicator includes trigger having a connector configured for reversible connection to said egress.

7. The system of claim 1, wherein said egress includes multiple openings for release of said compound.

8. The system of claim 7, wherein said multiple openings are evenly spaced along a line.

9. The system of claim 1, wherein the conveyer is flexible.

10. A system for spreading compound onto a surface comprising:
a mixing tank configured for storing and mixing the compound;
an applicator configured for spreading the compound onto the surface according to a predefined pattern;
a conveyer connecting providing a transport path for the compound from the mixing tank to the applicator;
a pump for driving the compound from the tank along the conveyer to the applicator;
said applicator including
an egress configured to release the compound
a blade with an uneven spreading edge fixed to said egress.

11. The system of claim 10, wherein said egress is configured to deposit the compound unevenly over a surface.

12. The system of claim 11, wherein the egress includes multiple outlets.

13. The system of claim 10, wherein said egress is configured to deposit the compound in multiple lines along the surface.

14. The system of claim 10, wherein said applicator includes a regulator for controlling a rate of said release of the compound.

15. The system of claim 10, wherein said applicator includes a meter for indicating a rate of said release of the compound.

16. A method for depositing an adhesive onto a surface comprising:
providing an adhesive spreading device include a mixer a conveyer and an applicator: mixing the adhesive in the mixer;
driving the adhesive along the conveyer to the applicator and
passing the applicator over the surface thereby depositing the adhesive unevenly across the surface.

17. The method of claim 16 further comprising:
measuring an actual deposition rate;
comparing said actual deposition rate to a desired deposition rate;
adjusting a regulator to bring said actual rate closer to said desired rate.

18. The method of claim 16, wherein said applicator includes an uneven blade and wherein said passing the applicator includes shaping the deposited adhesive unevenly with said uneven blade.

19. The method of claim 16, wherein said applicator includes an uneven egress and wherein said passing the applicator includes depositing said adhesive unevenly with said uneven egress.
